(19) United States
(12) Patent Application Publication
(10) Pub. No.: US 2005/0086082 A1
(43) Pub. Date: Apr. 21, 2005

(54) Portable health assistant

(75) Inventors: Mark L. Braunstein, Atlanta, GA (US); Stephen P. Miller, Atlanta, GA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Patient Care Technologies

(21) Appl. No.: 10/971,928

(22) Filed: Oct. 22, 2004

Related U.S. Application Data
(63) Continuation of application No. 09/490,019, filed on Jan. 21, 2000, now abandoned.
(60) Provisional application No. 60/116,642, filed on Jan. 21, 1999.

(51) Int. Cl. G06F 17/60

(52) U.S. Cl. 705/2

(57) ABSTRACT

A portable health assistant system having a portable health assistant, a computer server remotely accessible by the portable health assistant, and a Web browser through which a clinician can communicate with the computer server. The portable health assistant is a handheld microprocessor-based device with a display screen and a touch screen interface through which a patient can input information. Through multimedia software content, the portable health assistant provides the patient with such features as reminding the patient when to perform tasks in their prescribed treatment regimen, collecting information about the patient's compliance with the prescribed treatment regimen, collecting information about the patient's symptoms, providing the patient with educational information teaching the patient about the patient's disease, instructing the patient how to use a home health monitoring device, and receiving the readings of the monitoring device through a direct connection with the monitoring device. By communicating with the computer server, the portable health assistant can receive order updates from the clinician and transmit information collected from the patient to the server for review by the clinician. The clinician can review the patient information and issue orders modifying the patient's treatment regimen at the server itself or from a remote Web browser in communication with the server. The server can also send alerts to the clinician if the server determines that the patient data merits special attention from the clinician.

### CROSS-REFERENCE TO RELATED APPLICATION

This application claims the benefit of U.S. Provisional Application No. 60/116,642, filed Jan. 21, 1999, which is incorporated by reference.

### FIELD OF THE INVENTION

The present invention relates generally to health care, and more particularly relates to a portable device that can manage, educate, and monitor home-based medical patients and share information with a remote server accessible by health care providers through Web browsers.

### BACKGROUND OF THE INVENTION

Conventionally, health care providers have treated patients by prescribing treatment regimens for the patients to follow. In a typical treatment regimen, the patient is supposed to take prescription drugs at predetermined times, follow a recommended exercise program, and adhere to dietary restrictions. Often, there are multiple prescription drugs the patient must take. The clinician treating the patient typically reviews the patient's progress during a subsequent office visit, in which the clinician may modify the patient's treatment regimen.

There are many problems with this conventional method of providing health care to patients. Specifically, treatment regimens may be complicated. Accordingly, a patient may at times forget to follow an aspect of the treatment regimen prescribed for that patient. Hence, effectiveness of the treatment regimen is reduced.

Frequently, the clinician cannot determine patient compliance with the treatment program because the patient is either unable to remember if the patient complied or falsely states that the patient complied with the treatment program out of embarrassment. Hence, if the patient's health does not conform to the expectations of the clinician after prescription of the treatment regimen, the clinician may be unsure whether the reason is noncompliance by the patient with the treatment regimen or failure of the treatment regimen.

This gap in the clinician's knowledge is unfortunate. If, for example, the clinician knew that the patient was not compliant, then the clinician could either emphasize the importance of the patient following the treatment regimen or devise an easier to follow treatment program. If, on the other hand, the clinician knew that the patient was compliant but that the treatment regimen nevertheless failed, then the clinician could prescribe an alternative treatment regimen.

Another problem with conventional health care delivery also involves determining the effectiveness of the treatment program. Typically, that determination is made by the clinician based upon information the patient provides to the clinician in an office visit. While this information may give the clinician a general idea of how the patient has been feeling, this information is typically not detailed enough to allow the clinician to correlate symptoms with the timing of aspects of the treatment regimen, such as the taking of medication. Furthermore, the patient may not accurately remember all the symptoms experienced by the patient since the last time the patient visited the clinician. Accordingly, the ability of the clinician to advantageously modify the treatment regimen is reduced.

Therefore, there is a need in the art for an improved method of providing health care to patients the solves the problems of conventional health care delivery.

### SUMMARY OF THE INVENTION

The present invention meets the needs described above in a portable health assistant system. The patient is provided with a portable health assistant, which is a handheld microprocessor-based device with a display screen. The patient can input information into the portable health assistant through a touch screen interface.

Through multimedia software content, the portable health assistant advantageously provides the patient with numerous features. For example, the portable health assistant reminds the patient when to perform tasks, such as taking medications, in their prescribed treatment regimen. This feature provides the advantage of improving patient compliance with a complicated treatment regimen.

By querying the patient whether the patient has completed a task that the portable health assistant has reminded the patient to perform, the portable health assistant collects information about the patient's compliance with the prescribed treatment regimen. The portable health assistant then transmits this compliance information to the clinician treating the patient. This feature provides the advantage of helping the clinician to determine whether and how to modify the patient's treatment regimen to obtain the best results.

By collecting information from the patient about the patient's symptoms, the portable health assistant provides further advantages. The portable health assistant permits the patient to initiate reporting of symptom information at the time the patient is experiencing the symptoms. The portable health assistant may also instruct the patient to report symptoms at various times. Because the portable health assistant can record the time at which the patient reports symptoms, the portable health assistant can correlate the symptoms with the patient's schedule. This information advantageously helps the clinician to gauge the effectiveness of the treatment program.

The portable health assistant also has other features. For example, the portable health assistant provides the patient with educational information to teach the patient about the patient's disease. The portable health assistant can also instruct the patient how to use home health monitoring devices and receive the readings of such devices. A health monitoring device may be hooked up to the portable health assistant so that the device can automatically transmit measurements to the portable health assistant.

Through a periodic connection with a remote server, the portable health can also share information with a remote clinician. Specifically, the portable health assistant can receive order updates from the clinician modifying the tasks the portable health assistant reminds the patient to do. Also, the portable health assistant can transmit to the server for review by the clinician the information collected from the patient.

The server, in turn, may provide this patient information to clinicians remote from the server by transmitting this information over a computer network, such as the Internet, to the clinician's Web browser. The server can also send alerts to the clinician if the server determines that the patient data merits special attention from the clinician. In response, the clinician can enter order updates that the clinician's Web browser sends to the server for later transfer to the portable health assistant.

Generally described, the present invention includes a method for delivering health care through a portable health assistant that involves providing a patient with the portable health assistant. The clinician treating the patient configures the portable health assistant with a protocol having multimedia software content for treating the patient's disease through the portable health assistant. At a computer remote from the portable health assistant, the clinician receives patient data collected by the portable health assistant in accordance with the protocol.

The patient data may include an indicator of compliance by the patient with the treatment regimen associated with the protocol. The patient data may also include a symptom that the patient reported to the portable health assistant. The clinician may also receive an alert that the patient data merits review by the clinician.

From the remote computer, the clinician also sends to the portable health assistant an order modifying how the protocol treats the disease. The order includes a task that the portable health assistant reminds the patient to perform at a predetermined time.

The remote computer may be a server that the portable health assistant periodically accesses. Alternatively, the remote computer may be located remotely over a computer network from a server to which the portable health assistant sends the patient data. In this case, the server then transfers the patient data to the remote computer. The computer network can be the Internet, and the clinician can communicate with the server from the remote computer using a Web browser.

The present invention includes providing health care under the supervision of a remote clinician. The portable health assistant reminds a patient when to perform a task included in an order for treating the patient. The portable health assistant receives the order from the clinician during a periodic connection with a remote server. The portable health assistant receives from the patient an indication of a symptom experienced by the patient. The portable health assistant also sends notification of the symptom to the remote server during a periodic connection with the remote server so that the clinician can evaluate the need for a new order.

When reminding the patient when to perform the task included in the order, the portable health assistant may generate an audible alarm to get the patient's attention. The portable health assistant may also provide the patient with instructions for performing the task.

The present invention includes a portable health assistant system including a portable health assistant, a computer server remote from the portable health assistant, and a Web browser remote from both the portable health assistant and the computer server. The portable health assistant is functional for performing the following functions: periodically forming a communication connection with the computer server; receiving orders from the clinician for treating the patient; reminding the patient when to perform tasks included in the orders; collecting information from the patient about symptoms experienced by the patient and compliance by the patient with a prescribed treatment regimen; and sending the information to the computer server over the communication connection. The computer server is functional for performing the following functions: sending the information over the Internet to the clinician's Web browser; determining if the information meets predetermined criteria indicating that the clinician should be specially notified of the information; sending an alert to the clinician if the information meets the predetermined criteria indicating that the clinician should be specially notified of the information; receiving the orders from the clinician; and sending the orders over the communication connection to the portable health assistant. The Web browser is functional for performing the following functions: displaying the alert to the clinician; displaying the information to the clinician; and transmitting the orders from the clinician over the Internet to the computer server.

The various aspects of the present invention may be more clearly understood and appreciated from a review of the following detailed description of the disclosed embodiments and by reference to the appended drawings and claims.

### BRIEF DESCRIPTION OF THE DRAWINGS

FIG. 1 is a block diagram illustrating a portable health assistant system in accordance with an exemplary embodiment of the present invention.

FIG. 2 is a diagram having screen shots illustrating the entry and execution of a new order in accordance with an exemplary embodiment of the present invention.

FIG. 3 is a diagram having screen shots illustrating the triggering and processing of an alert in accordance with an exemplary embodiment of the present invention.

FIG. 4 is a diagram having screen shots illustrating conditional logic in a protocol in accordance with an exemplary embodiment of the present invention.

FIG. 5 is a screen shot of a CareView in accordance with an exemplary embodiment of the present invention.

FIG. 6 is a screen shot of a WELL.AT.HOME introductory main menu screen in accordance with an exemplary embodiment of the present invention.

FIG. 7 is a screen shot of an alarm screen in accordance with an exemplary embodiment of the present invention.

FIG. 8 is a screen shot of an authorized users screen in accordance with an exemplary embodiment of the present invention.

FIG. 9 is a screen shot of a Things To Do Now screen in accordance with an exemplary embodiment of the present invention.

FIG. 10 is a screen shot of a screen instructing the patient to take the medication Zoloft in accordance with an exemplary embodiment of the present invention.

FIG. 11 is a screen shot of a screen showing selection of an answer to a question associated with a task in accordance with an exemplary embodiment of the present invention.

FIG. 12 is a screen shot of a Things To Do Now screen in which a check mark indicates a completed task in accordance with an exemplary embodiment of the present invention.

FIG. 13 is a screen shot of a screen for reporting symptoms in accordance with an exemplary embodiment of the present invention.

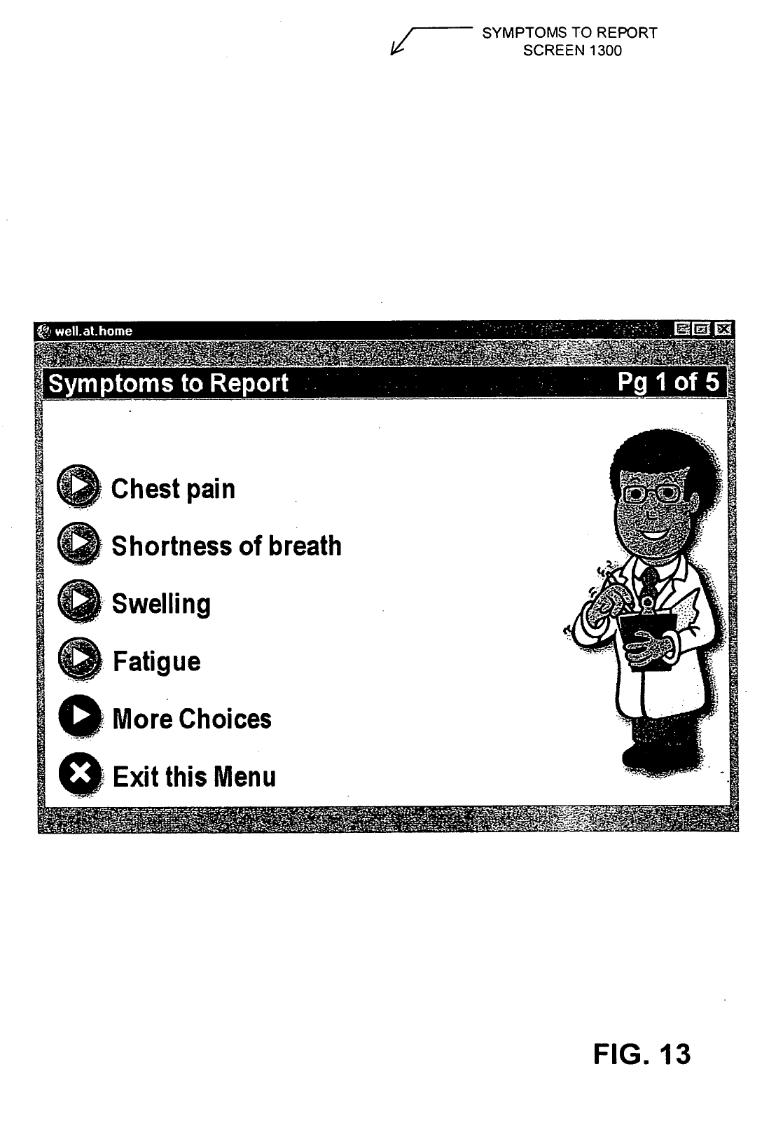

FIG. 14 is a screen shot of a screen allowing a patient to choose a topic about the patient's disease for which the patient would like to receive educational information in accordance with an exemplary embodiment of the present invention.

FIG. 15 is a screen shot of a patient schedule in accordance with an exemplary embodiment of the present invention.

FIG. 16 is a screen shot of a health status menu screen in accordance with an exemplary embodiment of the present invention.

FIG. 17 is a screen shot of a screen for displaying information about an order in accordance with an exemplary embodiment of the present invention.

FIG. 18 is a screen shot of a screen displaying a menu of care providers on the patient's care team in accordance with an exemplary embodiment of the present invention.

### DETAILED DESCRIPTION OF EXEMPLARY EMBODIMENTS

The present invention is typically embodied in a portable health assistant system having a portable health assistant, a computer server remotely accessible by the portable health assistant, and a Web browser through which a clinician can communicate with the computer server. The portable health assistant is a handheld microprocessor-based device with a display screen and a touch screen interface through which a patient can input information. Through multimedia software content, the portable health assistant provides the patient with such features as reminding the patient when to perform tasks in their prescribed treatment regimen, collecting information about the patient's compliance with the prescribed treatment regimen, collecting information about the patient's symptoms, providing the patient with educational information teaching the patient about the patient's disease, instructing the patient how to use a home health monitoring device, and receiving the readings of the monitoring device through a direct connection with the monitoring device.

By communicating with the computer server, the portable health assistant can receive order updates from the clinician and transmit information collected from the patient to the server for review by the clinician. The clinician can review the patient information and issue orders modifying the patient's treatment regimen at the server itself or from a remote Web browser in communication with the server. The server can also send alerts to the clinician if the server determines that the patient data merits special attention from the clinician.

General Features of the Portable Health Assistant System

Generally described, the portable health assistant system uses software and hardware for providing remote management, education, and monitoring of home-based medical patients. The patient is provided with an apparatus called a portable health assistant, also known as the “WELL.AT.HOME” device. One feature of the portable health assistant is that the software is highly structured, so the patient inputs all information into the portable health assistant by selecting from a list of choices via a touch screen. There need be no mouse or keyboard input from the patient.

Similarly, clinicians responsible for patient health typically enter information by using a mouse to select from a list of choices. However, these clinicians may also need to type names and similar information at the server or through a Web browser in communication with the server.

Another feature of the portable health assistant system is that the system is protocol driven. A protocol typically comprises a comprehensive library of multi-media content designed to deal with a specific disease. The content is “dynamic” in that its behavior is modified by conditional logic built into the protocol.

A protocol is in turn modified by the patient's specific orders. Clinicians responsible for a patient's health can enter or update orders remotely at the server or from a Web browser connected to the server. As orders change, the content delivered to the patient automatically changes accordingly. Generally, an order may comprise instructions from the clinician to the patient to perform any of the following tasks at times specified by the clinician: taking a given medication, performing an exercise, taking a physiological measurement, or reporting symptoms. Turning now to the figures, in which like numerals refer to like elements throughout the several figures, aspects of the portable health assistant system 100 are described.

Architecture and Data Flow in a Typical Portable Health Assistant System

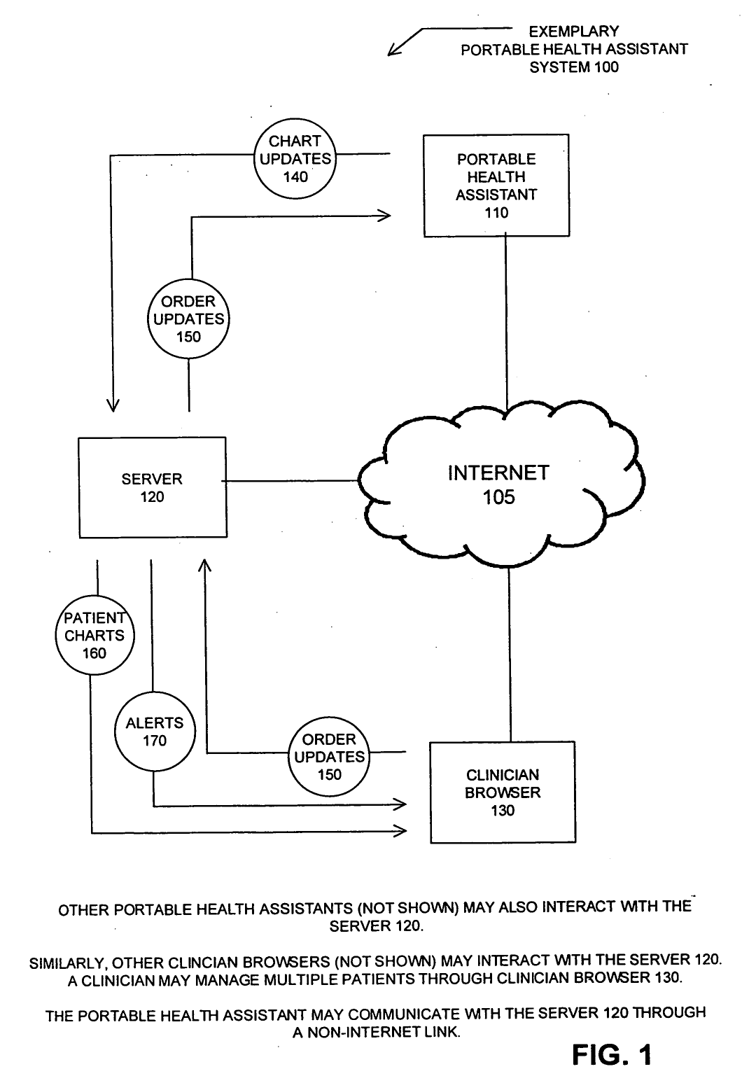

FIG. 1 illustrates the general network architecture and data flow in an exemplary portable health assistant system 100. As may be seen, the portable health assistant system comprises three major components. The first component is a portable health assistant 110 running client software for use by the patient in the home. The second component is a server 120 running server software which collects information from and provides information to a set of portable health assistants, such as the portable health assistant 110. The third component is the clinician browser (or “browser software”) 130. By interacting with the server 120, the clinician browser 130 provides clinicians with ubiquitous remote access to clinical information and the ability to view and update patient orders. The clinician browser 130 may comprise a commonly used Web browser, a commonly used Web browser with a special plug-in providing particular functionality for interacting in the portable health assistant system 100, or other suitable means.

Typically, data flows between the clinician browser 130 and the server 120 through the Internet 105. However, the browser 130 and the server 120 may communicate through other types of network connections known to those skilled in the art.

Typically, the portable health assistant 110 and the clinician browser 130 do not communicate directly. Rather, they communicate indirectly through the server 120. The portable nature of the portable health assistant 110 arises because the portable health assistant is a handheld device small enough to be easily carried around by the patient and because the portable health assistant need be linked to the Internet 105 only during the transfer of information between the server 120 and the portable health assistant. Like the connection between the clinician browser 130 and the server 120, the connection between the portable health assistant 110 and the server can be another type of network connection than a connection over the Internet 105.

In FIG. 1, the circles 140, 150, 160, and 170 represent data transferred over the Internet between the components 110, 120, and 130 of the portable health assistant system. Each circle is associated with a directional line from the component sending the data represented by that circle to the component receiving the data.

Still referring to FIG. 1, the portable health assistant 110 monitors the patient to collect patient data, which the portable health assistant transfers to the server 120 through chart updates 140. The server 120 examines the chart updates 140 to determine if the data merits immediate attention by a clinician. If so, the server 120 generates an alert 170, which the server sends to the clinician, typically through the browser 130. Upon request from an authorized clinician, the server 120 sends patient charts 160 containing patient data, which includes chart updates 140, to the clinician at the clinician browser 130 for review. Based upon instructions from the clinician reviewing the patient chart 160 or alerts 170, the clinician browser 130 sends order updates 150 to the server 120, which in turn transfers those order updates to the portable health assistant 110 during a later connection.

Other portable health assistants (not shown) may also interact with the server 120, allowing the portable health assistant system to manage a multitude of patients. Similarly, other clinician browsers (not shown) may interact with the server 120, thereby allowing a multitude of clinicians to participate in the management of patients participating in the portable health assistant system. Furthermore, a single clinician may manage multiple patients through a single clinician browser 130.

The portable health assistant 110, the server 120, and the computer on which the clinician browser 130 runs may each have typical features of a computer system, such as a processing unit, a system memory containing random access memory (RAM) and read only memory (ROM), and a system bus that couples the system memory to the processing unit. These computers may also include one or more memory storage devices, such as a hard disk drive, a magnetic disk drive (e.g., to read from or write to a removable magnetic disk), an optical disk drive (e.g., to read from or write to optical media such as a CD-ROM), or other permanent storage medium.

A number of program modules may be stored in the permanent storage mediums and RAM of each computer system. Program modules control how the computer system functions and interacts with the user, with input/output devices, or with other computers. Program modules include routines, an operating system, application program modules, data structures, browsers (such as clinician browser 130), and other software or firmware components.

In an exemplary embodiment, the portable health assistant 110 runs the WINDOWS CE operating system, the server 120 runs the WINDOWS NT operating system, and the computer running the clinician browser 130 runs the WINDOWS 98 operating system. The WINDOWS operating systems are produced by Microsoft Corporation of Redmond, Wash. The present invention may conveniently be implemented in various program modules (such as the client software, the server software, and the clinician browser 130) that are stored on the computers of the portable health assistant system 100.

No particular programming language will be described for carrying out the various procedures described in the detailed description because it is considered that the operations, steps, and procedures described and illustrated in the accompanying drawings are sufficiently disclosed to permit one of ordinary skill in the art to practice an exemplary embodiment of the present invention. Moreover, there are many computers and operating systems which may be used in practicing an exemplary embodiment, and therefore no detailed computer program could be provided which would be applicable to all of these many different systems. Each user of a particular computer will be aware of the language and tools which are most useful for that user's needs and purposes.

Client Software for the Portable Health Assistant

In an exemplary embodiment of the present invention, client software operates on the portable health assistant 110. The client software typically includes at least one protocol for a disease of the patient. The protocol utilizes a combination of text, pictures, pre-recorded sounds, and animations to manage the patient's disease.

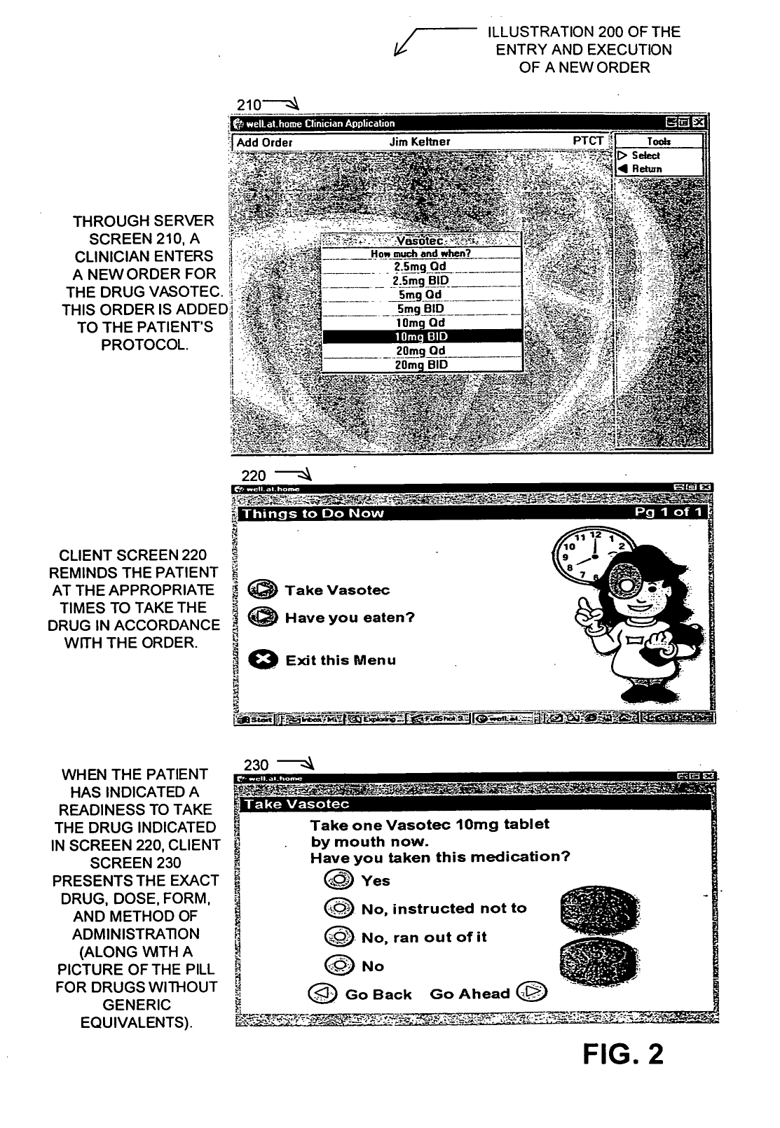

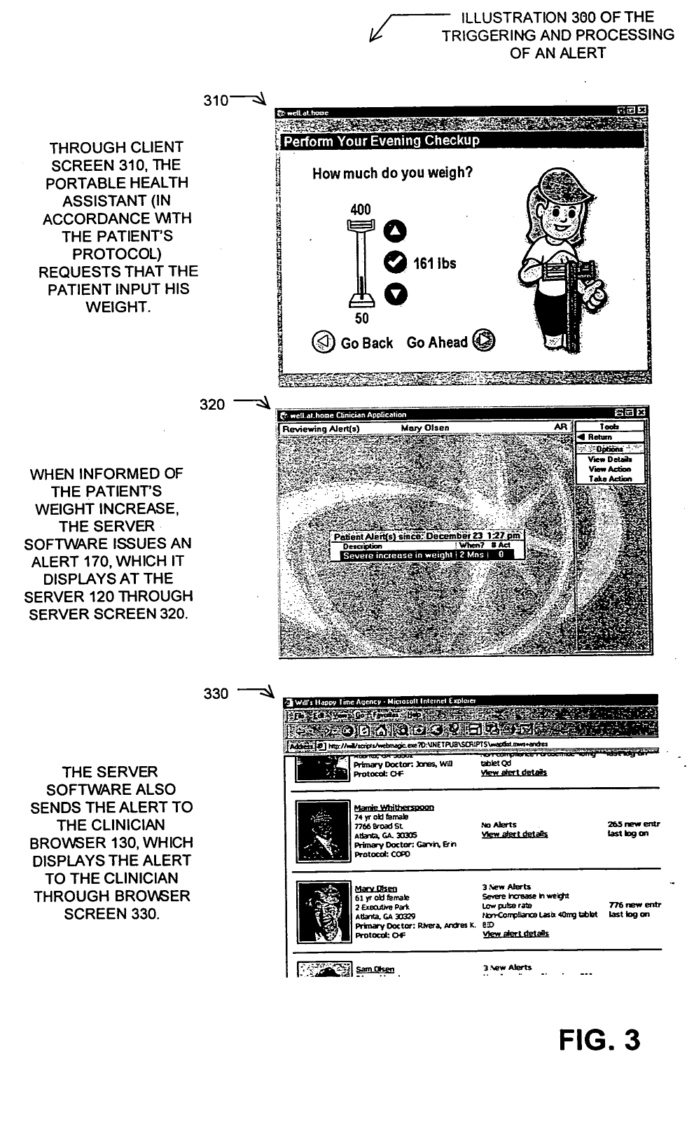

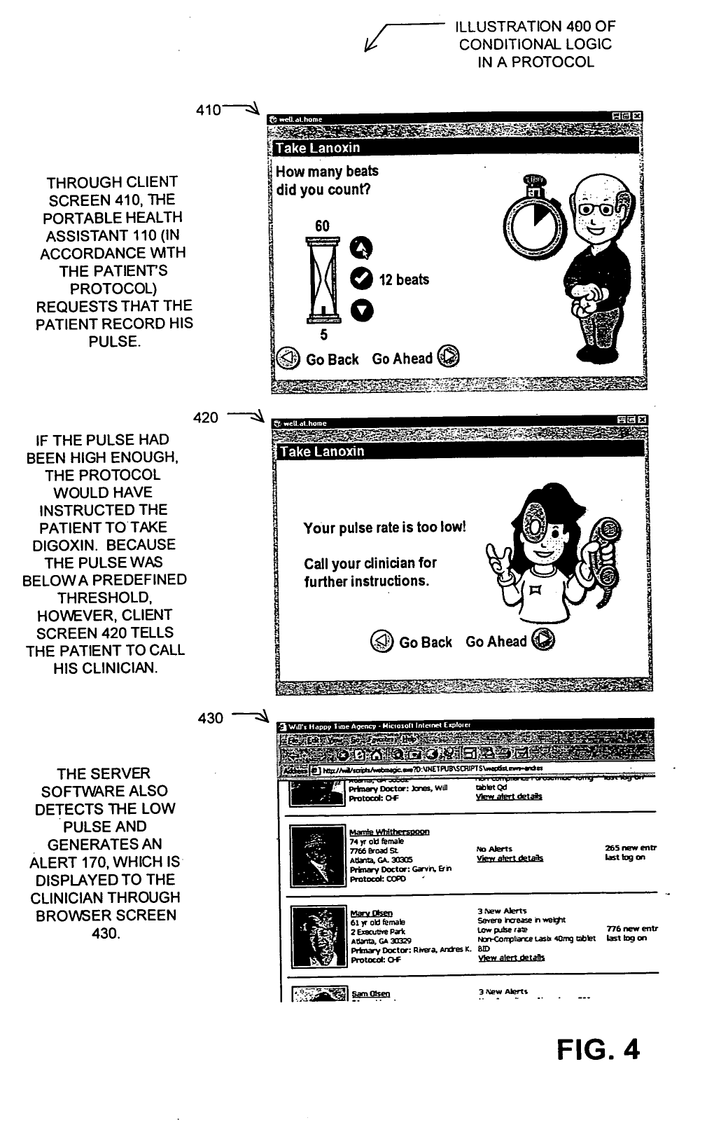

One function of the protocol is to remind patients of scheduled activities, such as medications, exercise, meals, and physiologic measurements. For example, client screen 220 of FIG. 2 reminds the patient at the appropriate times to take a drug in accordance with a clinician order. Likewise, client screen 230 of FIG. 2 presents the exact drug, dose, form, and method of administration of a drug the patient is ready to take. Client screen 230 may include a picture of the pill for drugs without generic equivalents. In FIG. 3, client screen 310 instructs the patient to weigh himself and enter his weight into the portable health assistant 110. Similarly, the portable health assistant 110 uses client screen 410 of FIG. 4 to prompt the patient to take his pulse and enter that pulse into the portable health assistant prior to taking a drug.

The client software of the portable health assistant 110 can have an alarm to automatically remind patients to perform scheduled activities. The patient can also query the portable health assistant 110 for a list of “Things To Do Now.” Clinicians authorized to treat the patient may add scheduled activities to the patient's protocol through orders 170.

A second function of the client software of the portable health assistant 110 is to educate patients about their disease, medications, diet, exercise program, and the use of other devices that may be attached to the portable health assistant. The client software of the portable health assistant 110 can maintain a list, accessible by the patient, of relevant multimedia educational material for the patient to review through the portable health assistant. This list may be identified as “Things to Learn.”

A third function of the client software of the portable health assistant 110 is to monitor the development and progression of the disease process of the patient. This may include tracking the emergence of predicted symptoms and side effects of the patient's disease and/or medication program. When the patient has symptoms to report, the patient can enter them into the portable health assistant 110 through a “Symptoms to Report” screen.

The client software of the portable health assistant 110 also collects information about the patient's compliance with scheduled activities, the patient's comprehension of educational information, and specific physiologic findings (including vital signs such as pulse, weight, and blood pressure).

The Server Software

The server software typically operates on a server such as the server 120. The server software provides for adding new patients into the system; linking patients to one or more pre-defined protocols; entering an initial set of orders for the patient (as in server screen 210 of FIG. 2); changing orders as the clinician modifies them; and tracking (at a central place) patient compliance, comprehension of teaching materials, and clinical progress.

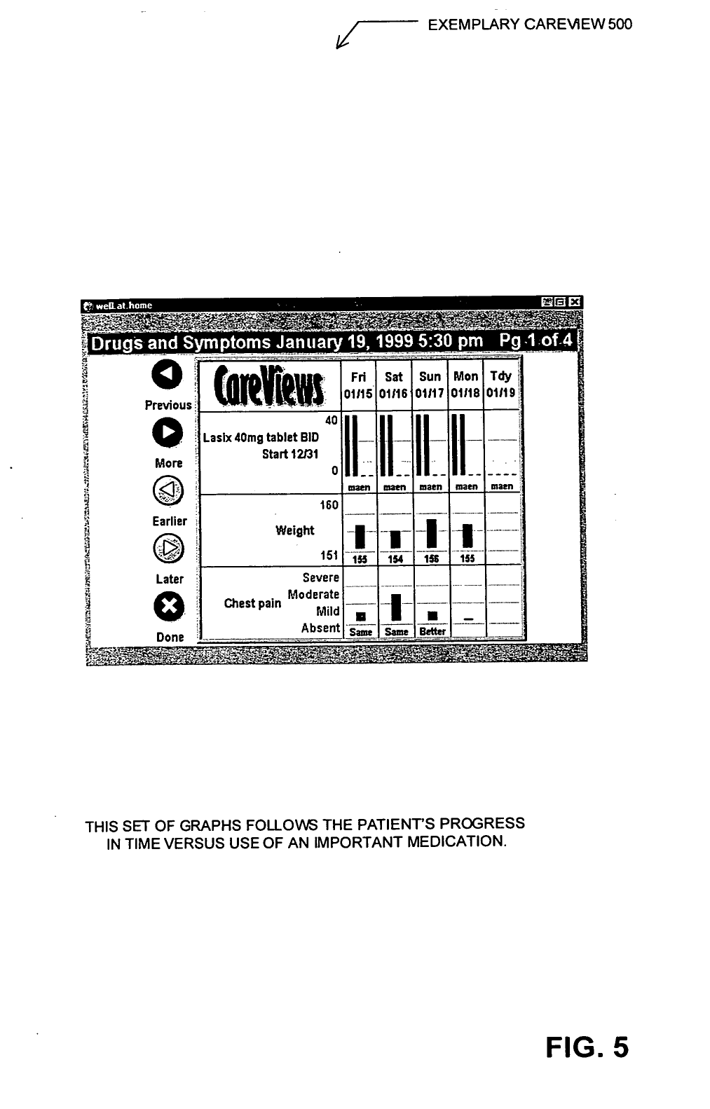

The tracking function is enhanced by “CareViews,” which are graphical presentations of a “panel” of data that closely emulate the flowcharts commonly used by clinical practitioners in patient care. An exemplary CareView 500 is shown in FIG. 5. CareView 500 shows a set of graphs that follows the patient's progress in time versus use of an important medication. The server 120 may provide CareViews to clinicians at the server itself or to the clinician browser 130 for review by a remote clinician.

The server software also uses pre-defined “rules” to create alerts 170 when incoming data from the client software meets certain criteria. FIG. 3 shows an exemplary illustration 300 of the triggering and processing of an alert. In client screen 310 of FIG. 3, the portable health assistant 110, in accordance with a patient's congestive heart failure protocol, requests that the patient input his weight. At a later time, the portable health assistant 110 uploads this information to the server 120. Because the patient gained more weight than allowed by the protocol, the server software issues an alert 170, which it displays at the server 120 through the server screen 320 to bring this potentially problematic change to the attention of the clinician using the server software. Instead, the server software could send the alert 170 to the clinician browser 130, which displays the alert to the clinician through the browser screen 330.

In summary, a clinician can utilize the server software at the server 120 to update patient data, monitor patient compliance, and assess clinical progress. The server software can also provide these capabilities to a remote clinician by communicating with clinician browser 130.

The Browser Software

The browser software 130 duplicates much of the functionality of the server software but does so over the Internet 105 with only the need for a browser (e.g., MICROSOFF'S INTERNET EXPLORER or NETSCAPE'S NAVIGATOR). The browser software 130 can be used by physicians, case managers, and others located remotely from the server 120.

Protocols

Protocols consist of a large set of “screens” designed specifically for the clinical requirements of a particular disease. Each “screen” consists of text; a picture or animation, and a pre-recorded voice which typically “reads” the same text information that is being displayed. Protocols may be directed to such conditions as congestive heart failure (CHF), hypertension, type II (adult onset) diabetes, type I juvenile onset) diabetes, chronic obstructive pulmonary disease (COPD), and asthma.

Protocols also consist of “rules” which govern the behavior of the client and/or server software under pre-specified conditions. Because the behavior of the client software or server software may vary depending on the predetermined conditions, these protocols employ what is referred to as “conditional logic.”

FIG. 4 illustrates the use of conditional logic in a protocol. In client screen 410 of FIG. 4, for example, a rule of the patient's protocol specifies that the portable health assistant 110 instruct the patient to measure the patient's pulse before taking the drug Digoxin. The patient then enters this pulse into the portable health assistant 110. In an example of conditional logic, the protocol would have instructed the patient to take digoxin if the pulse had been high enough. Because the pulse was below a predefined threshold, however, client screen 420 tells the patient to call his clinician.

A similar rule might generate an alert 170 at the server 120 or via the browser software 130 bringing this unusually low pulse rate to the specific attention of a clinician. For instance, browser screen 430 of FIG. 4 shows an exemplary screen for alerting a clinician using browser software 130 of this low pulse rate. Other rules might cause a clinician to be paged or to receive an alert via fax or e-mail in this situation. Thus, predefined rules that are part of a protocol may generate alerts 170 based on specific events which occur or data retrieved from the patient by the portable health assistant 110. These alerts 170 notify appropriate clinicians, such as an interested MD or case manager, of the specific event or data forming the basis for the alert.

An important design aspect of the present invention is that protocols are easily modified to the particular requirements of a patient, physician or institution without the need for programming.

Orders

Orders tell the protocol how to behave specific to the needs of a particular patient. In other words, protocols are generalized sets of possibilities for anyone with a particular chronic disease. Orders make the protocol specific to a particular patient. This concept is central to the present invention and distinguishes it, for example, from generic patient education programs or Web-based programs through which patients read information in a browser that may be specific to their condition but not specific to them.

FIG. 2 is an illustration 200 of the entry and execution of a new order. Through server screen 210 (or a similar screen at clinician browser 130), a clinician enters a new order for the drug Vasotec. This order is added to the patient's protocol and downloaded to the patient's portable health assistant 110. At the appropriate times in accordance with the order, the client screen 220 reminds the patient to take the drug. When the patient has indicated a readiness to take the drug indicated in screen 220, the client screen 230 presents the exact drug, dose, form, and method of administration for the drug. The screen 230 may also include a picture of the pill for drugs without generic equivalents.

Also central to orders is the concept of the clock. The client software is set up so that it knows when a patient typically awakens, eats meals, and goes to bed. Orders contain information as to how many times during the day and “when” during the day they should be performed. The combination of the specification within the order and the knowledge of the patient's daily schedule allows the client software to “remind” the patient when (within their regimen) to take medications, perform exercises, eat meals, or do other activities prescribed by their physician.

Orders may also be dependent on other orders. For example, a patient might be asked to perform an exercise routine (one order) before taking their pulse (a second order).

Provision of Data to Home Care Clinicians

The system may provide home care clinicians with access to the patient's data in the system. This provision to home care clinicians of clinical data input directly by the patient into an electronic patient record is a potentially unique aspect of the present invention. It could facilitate, among other things, the performance of tightly focused home care visits on a more “as needed” basis.

Data Collection from Peripheral Devices of the Portable Health Assistant

The client software running on the portable health assistant 110 could train the patient on the use of an in-home measurement device (not shown), such as an ECG, BP, spirometer, or pill counter. The client software could also direct the patient to make measurements using the device and then enter the measurements manually into the portable health assistant for inclusion in the patient's digital health record.

Alternatively, the in-home measurement device could be a peripheral which connects to the portable health assistant through a port, such as a PC card port, a USB port, or an infrared port. In this setup, the measurement device could automatically provide the client software with the collected data for inclusion in the patient's record.

Exemplary Patient Training Manual

In order to provide further disclosure about the operation of the portable health assistant 110, the detailed description now provides an exemplary training manual describing to users the operation of the portable health assistant. In this manual, the portable health assistant 110 is referred to as the WELL.AT.HOME device.

### Beginning of Patient Training Manual

### Overview of the Patient Application

Welcome to WELL.AT.HOME! The WELL.AT.HOME system was created to give you, the patient, the opportunity to contribute to your own care. Among other things, WELL.AT.HOME allows you to enter information about your condition, view information about your orders, and learn more about controlling your disease and improving your health.

WELL.AT.HOME is like having a clinician in your home each day, since the information you enter in to the system is sent back to your health care agency on a daily basis. Your clinician reviews the information you enter and makes changes to your treatment plan as needed.

WELL.AT.HOME also has a reminder feature to help you remember to complete items assigned for your care in a timely manner. This ensures your treatment is most effective for combating your illness.

This guide provides you with step-by-step instructions on how to use WELL.AT.HOME. As you read through this manual, you will be introduced to the various features of the system and learn how they can benefit you.

### Getting Started

### The WELL.AT.HOME Screen

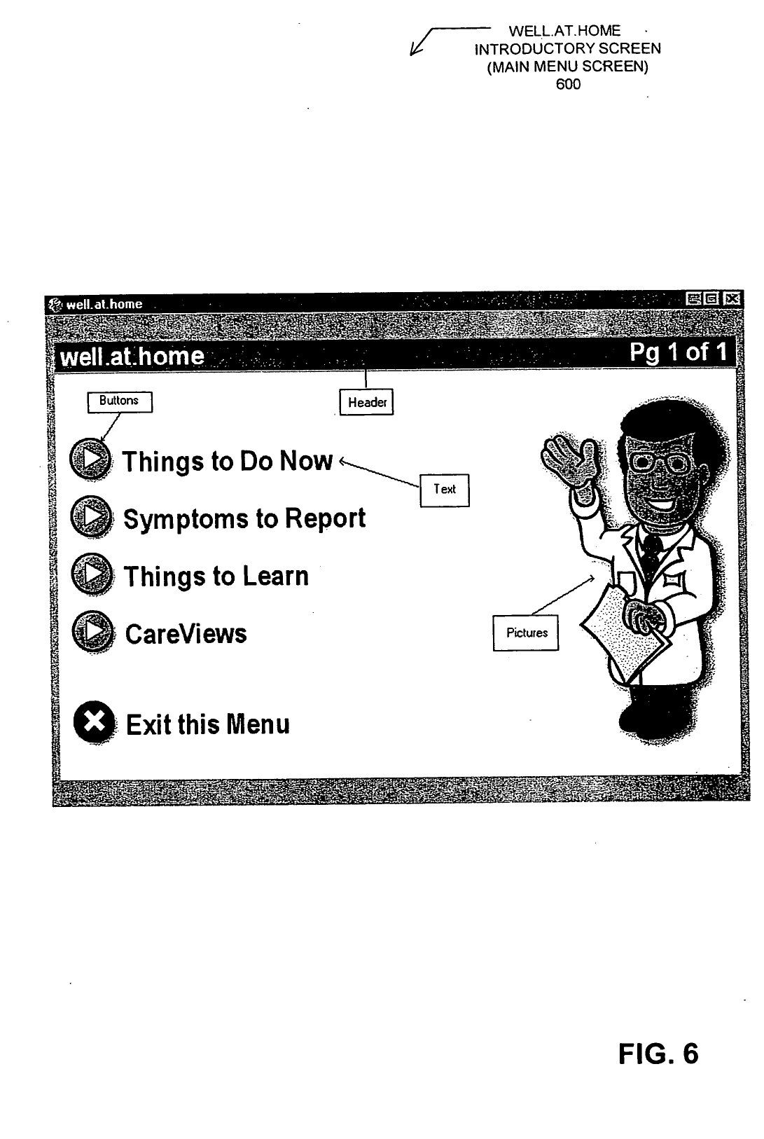

A WELL.AT.HOME screen consists of a header, touchable buttons, text, and pictures. A typical WELL.AT.HOME introductory screen 600 is shown in FIG. 6. The left corner of the header shows the name of the screen. For example, the name of the introductory screen 600 in FIG. 6 is “WELL.AT.HOME.” If a menu appears on the screen, the right corner of the header will display the page number. In introductory screen 600, the screen displays page one of a one-page menu.

### Touch Screen Guidelines

WELL.AT.HOME uses touch-screen technology. This allows you to move through the different screens and enter information simply by touching a button on the screen. To use WELL.AT.HOME properly, you should follow the following guidelines:
Make sure your hands are clean.
Clean the screen by gently wiping the surface with a dry soft cloth. Do not attempt to clean the screen with water or cleaning agents as these may damage it.
Make sure there is only one contact point on the screen. For example, if your palm is resting on the screen while you are touching a button, WELL.AT.HOME will not recognize the touch.

### Buttons

The buttons on the screen are used to navigate through the WELL.AT.HOME system. Simply touch the appropriate button for the action that you want to perform. The different buttons and their functions are described below.

### Green Button

Use the green buttons to select a menu item or to move forward from one page to the next. Just like a traffic light, if a button is green it is safe to go ahead.

### Yellow Button

Yellow buttons indicate that you may proceed, but like a yellow traffic light, it is best to stop and wait until the button turns green.

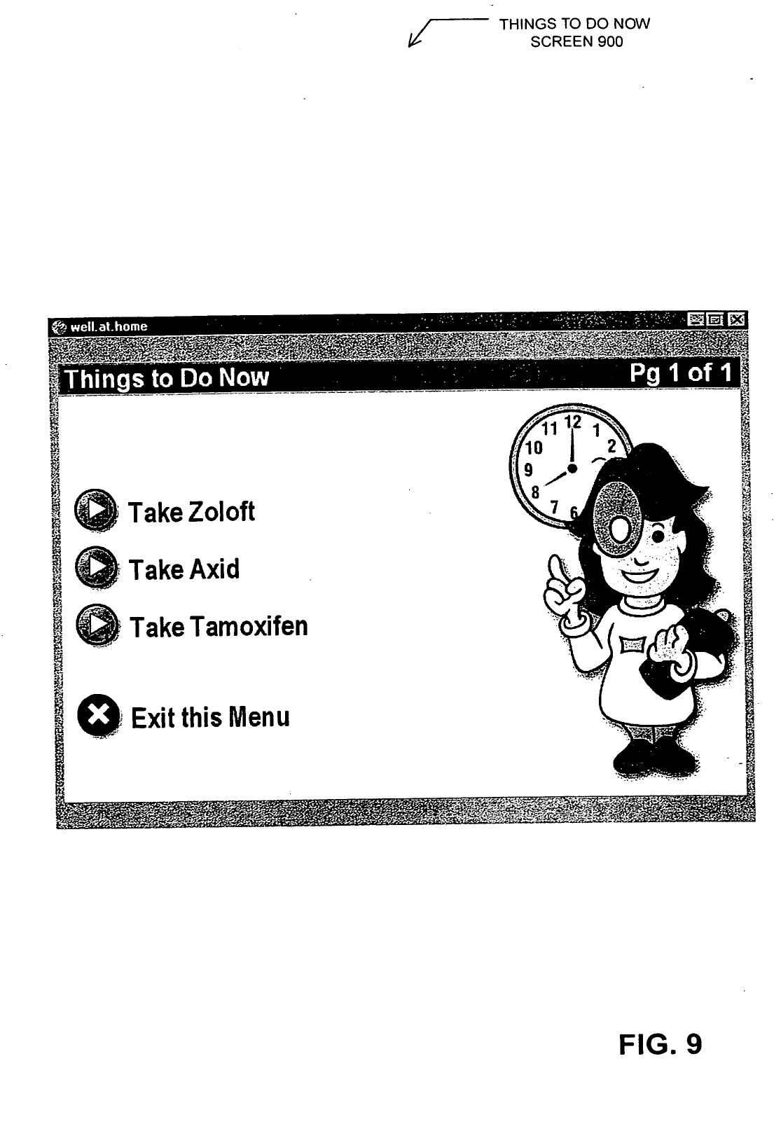

In the “Things To Do Now” menu 900 of FIG. 9, the yellow button with the arrow pointing right appears next to an order that has special circumstances. For instance, if your clinician has instructed you to eat before taking a specific medication, that medication will be marked with a yellow right arrow until you indicate that you have eaten. Once you complete the special circumstances, the yellow button will turn green.

In an information screen, the yellow button with the right arrow is used to move to the next page without entering the information that is asked for. If you wish to skip a question, you may touch this button and go forward. If you enter the information that is requested, this button will turn green.

The yellow button with the arrow pointing left is used to go to the previous page. This button will remain yellow regardless of whether or not you complete the information on that page because the preferred action is for you to move forward.

### Red Button

Use the red X button to stop using the current screen and return to the previous screen.

### Blue Button

Use the blue checkmark button to indicate that you have selected an answer to a question. If you select a different answer, the checkmark will move to that answer.

### Gray Button

The gray button is found next to all of the unchecked answers to a question. Once an answer is chosen the gray button becomes a blue checkmnark button.

### Purple Button

The purple arrow buttons indicate that more choices are available. The purple right arrow button will take you to the choices on the next page. The purple left arrow button will take you to the choices on the previous page. If you are on the first page of a list of choices, the left arrow button will not appear.

Use the purple buttons with the up and down arrows to enter numeric data. Use the purple button with the arrow pointing up to increase the numeric value of an answer. Use the purple button with the arrow pointing down to decrease the numeric value of an answer.

### How to Use WELL.AT.HOME

### Things to Do Now

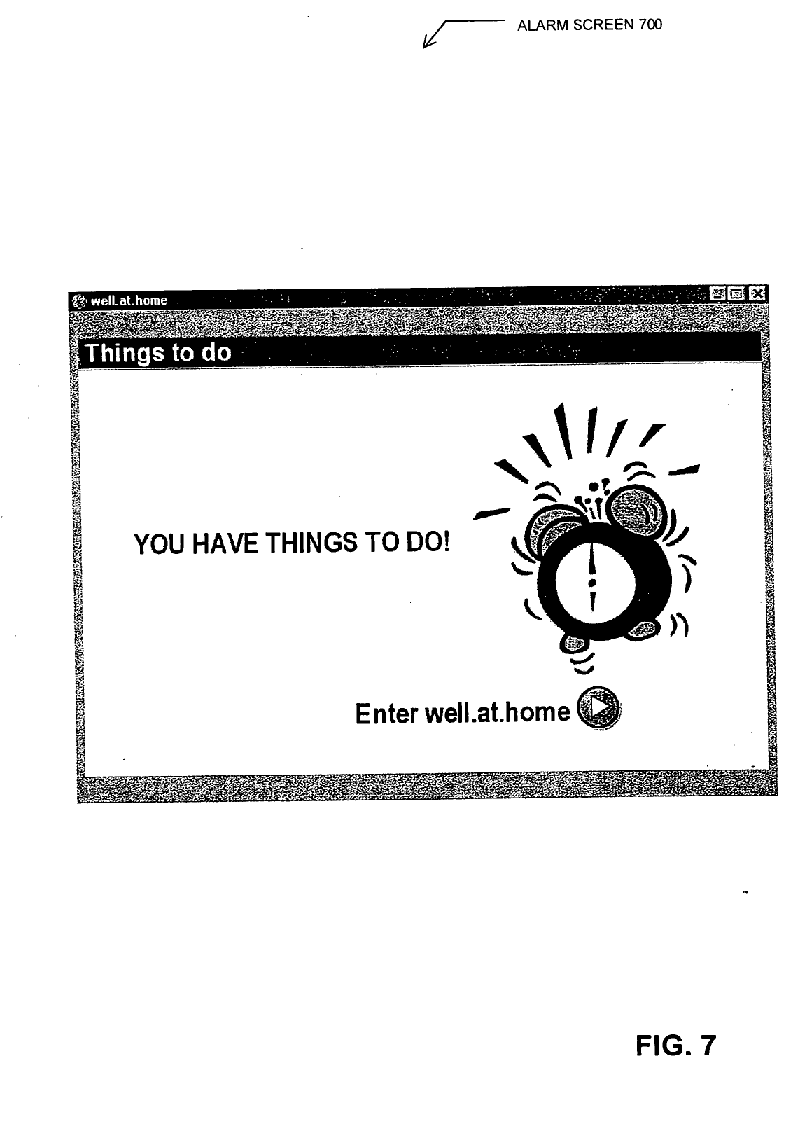

When the WELL.AT.HOME alarm rings, it is time for you to do a task. The WELL.AT.HOME alarm screen 700 of FIG. 7 appears. Enter the system by touching the green arrow button with “Enter WELL.AT.HOME” next to it.

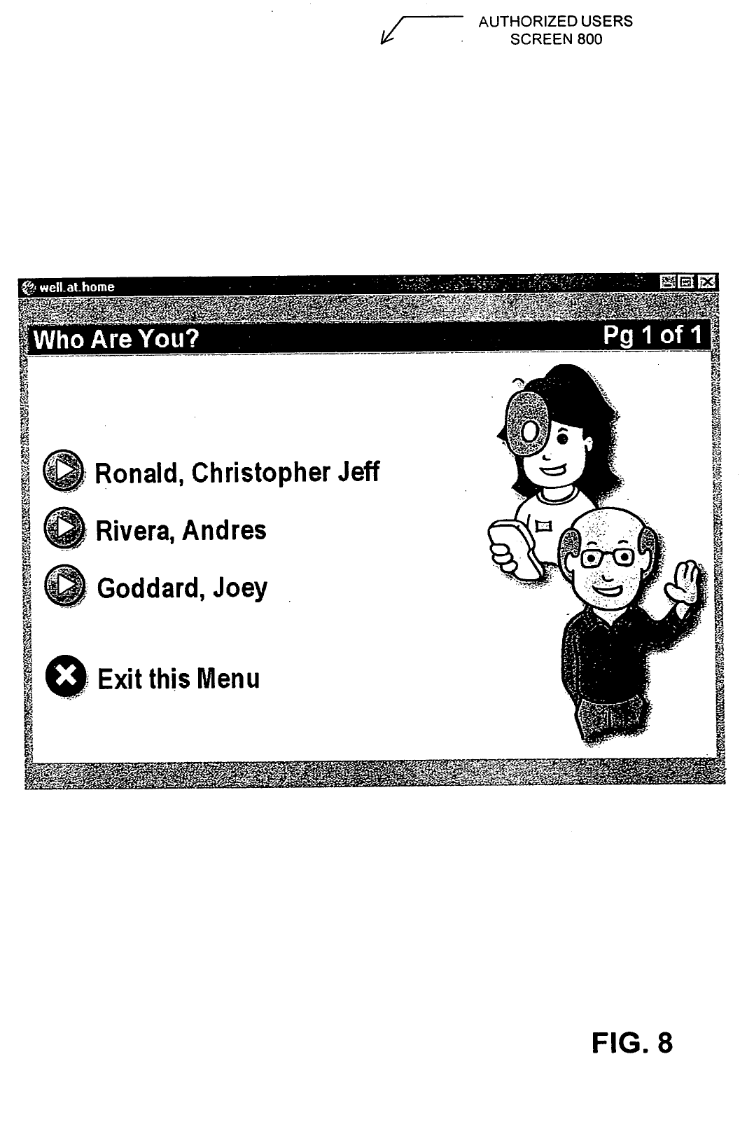

After touching the green arrow button of alarm screen 700, the authorized users screen 800 of FIG. 8 appears. The screen 800 includes a list of people who may use WELL.AT.HOME. Identify yourself by touching the green arrow next to your name.

Once you have identified yourself, the main menu screen 600 appears. Touch the green arrow button next to “Things to Do Now” to see the tasks you need to perform.

A list of the things that you need to do at this time appears. An exemplary “Things To Do Now” screen 900 is shown in FIG. 9. Examples of “Things To Do Now” tasks include performing a checkup, taking medication, or exercising. Tasks with green arrows should be performed first. In screen 900, the tasks “Take Zoloft,”, “Take Axid,” and “Take Tamoxifen” are to be done now. Green arrows are next to these tasks.

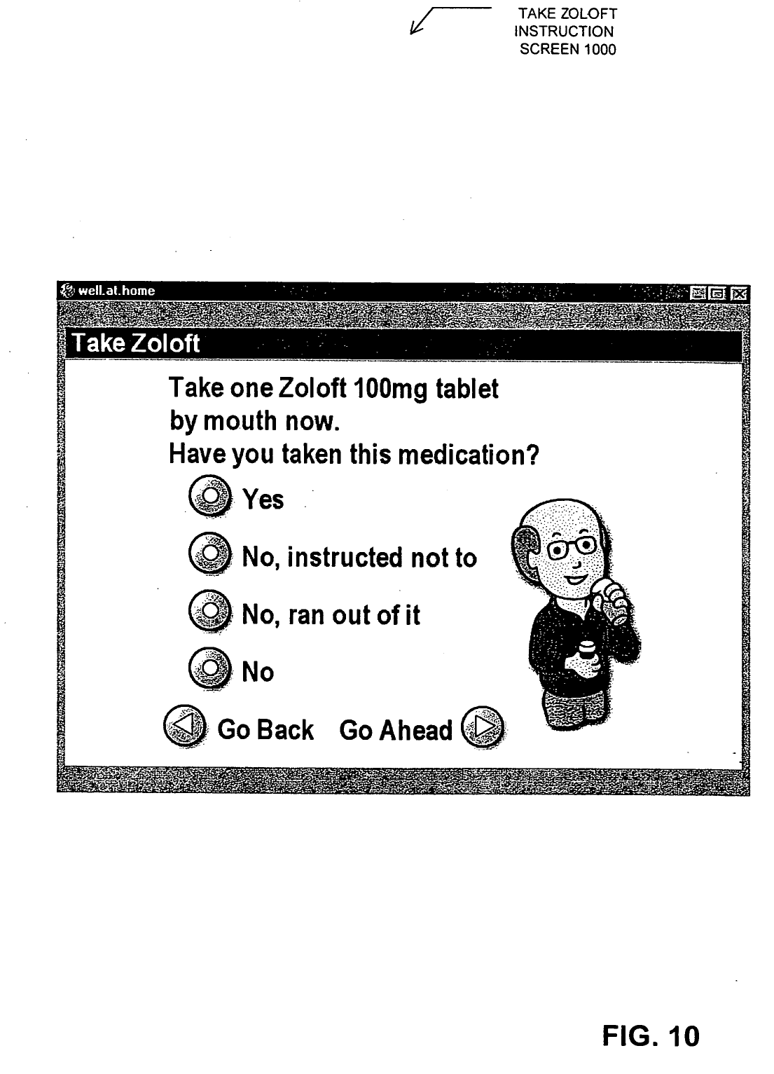

When you touch on the green arrow button next to a task, instructions on what to do next appear. For example, choosing the button next to the task “Take Zoloft” brings up an instruction screen 1000 (FIG. 10) for taking the Zoloft medication. The instructions tell you to take one Zoloft 100mg tablet by mouth now.

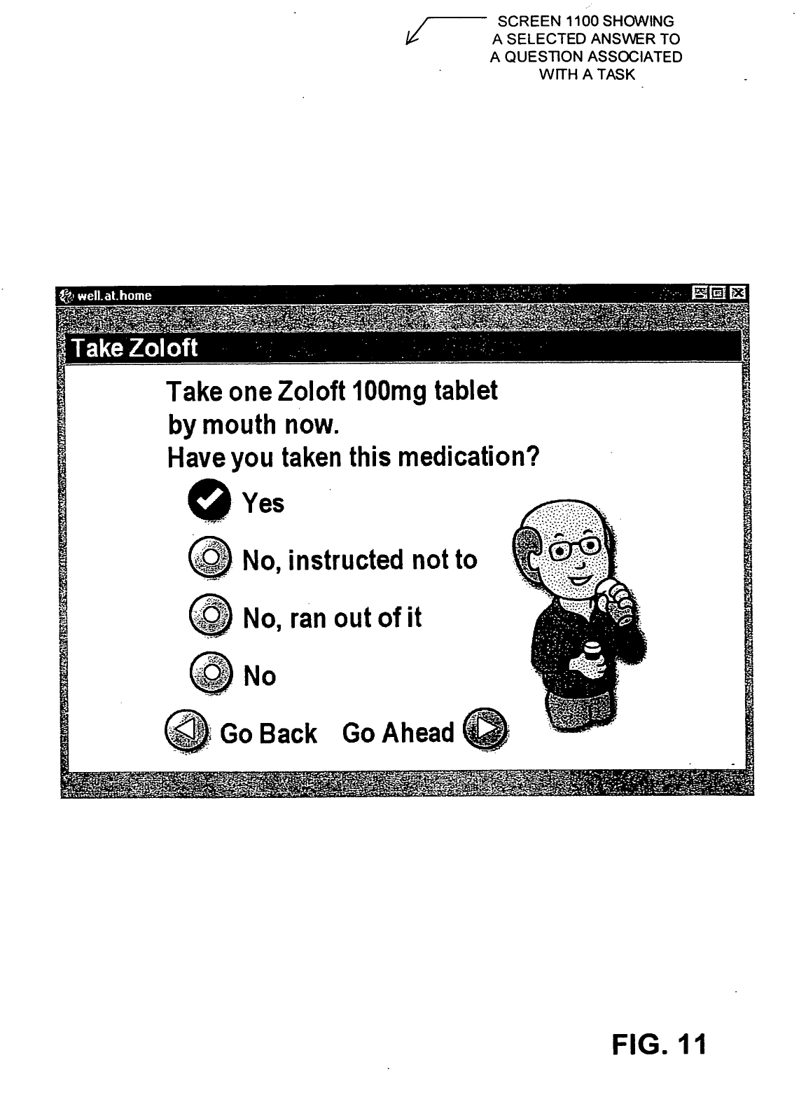

A take medication screen may also present a question associated with that task. For example, instruction screen 1000 asks you if you have taken the Zoloft medication as instructed. To answer a question associated with a task, touch the gray button next to the appropriate answer. When you select an answer, a blue check mark appears and the right arrow button to “Go Ahead” changes from yellow to green. For instance, screen 1100 of FIG. 11 appears after you select “YES” in screen 1000 of FIG. 10.

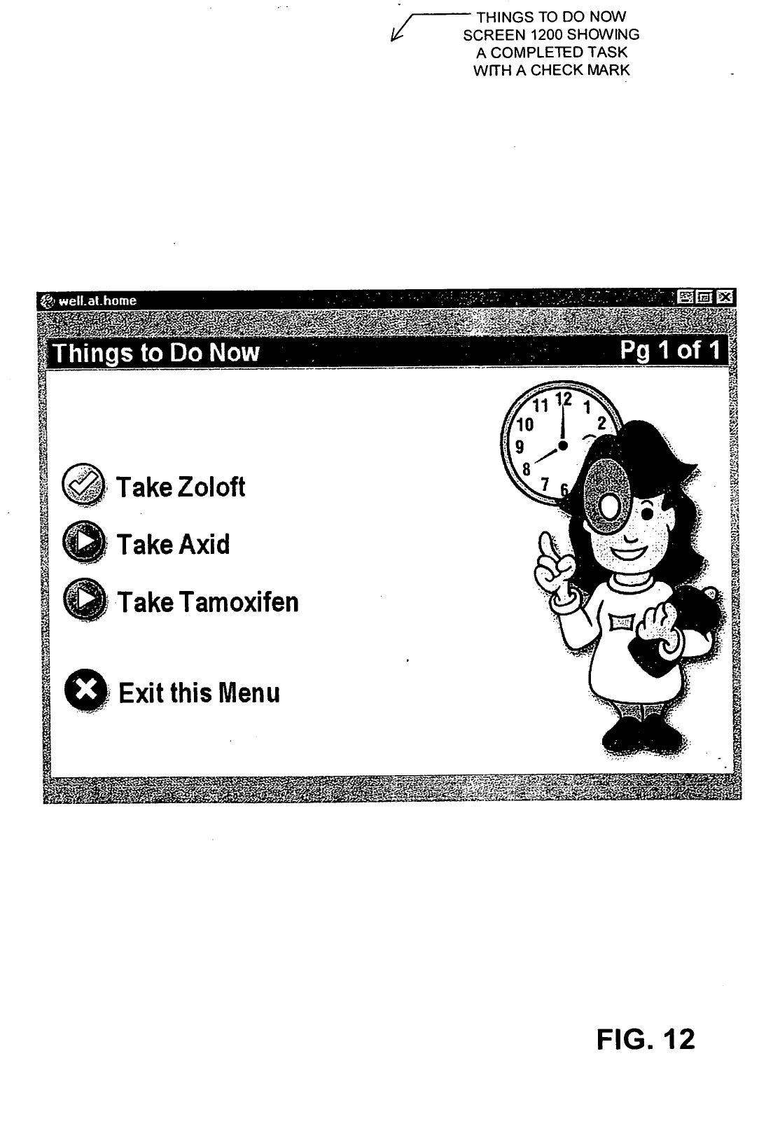

When you see a yellow checkmark next to a task in a “Things to Do Now” screen, that task is complete. For example, the “Things to Do Now” screen 1200 of FIG. 12 now shows a yellow checkmark next to the “Take Zoloft” task because that task is now complete. You can now move on to the next task with a green arrow next to it.

If a task has a yellow arrow next to it, there are special circumstances that should occur before you should perform this task. Wait until the yellow arrow turns green before entering this task.

When all of the tasks have yellow checkmarks next to them you may touch the red X button to exit the “Things to Do Now” list and return to the main menu screen 600 of FIG. 6. Importantly, you do not have to perform all of the tasks if you are not ready. WELL.AT.HOME will remember what you have left to do, and will remind you often to complete the unfinished tasks.

### Other Components

In addition to “Things To Do Now,” WELL.AT.HOME has three other components to help you monitor and learn about your illness and treatment. These include “Symptoms to Report,” “Things to Learn,” and “CareViews.”

### Symptoms to Report

If you are experiencing symptoms that you need to report, touch the Symptoms to Report button on the main menu screen 600. A screen, such as the “Symptoms to Report” screen 1300, appears with a list of categories of symptoms that are common to your disease.

After selecting a category of symptoms in screen 1300, you will be asked questions about your symptoms. Your responses to the questions about your symptoms are sent to your clinician so that he or she will be able to modify your treatment.

If you do not see a category of symptoms that is most descriptive of the symptoms that you are experiencing, touch the purple right arrow button for more choices. (Touch the purple left arrow to go back.)

Touch the button next to the appropriate category of symptom and answer the questions that follow. If you feel that a question is not appropriate to your symptom, you may leave the question unanswered. Simply touch the yellow right arrow button to move forward.

### Things to Learn

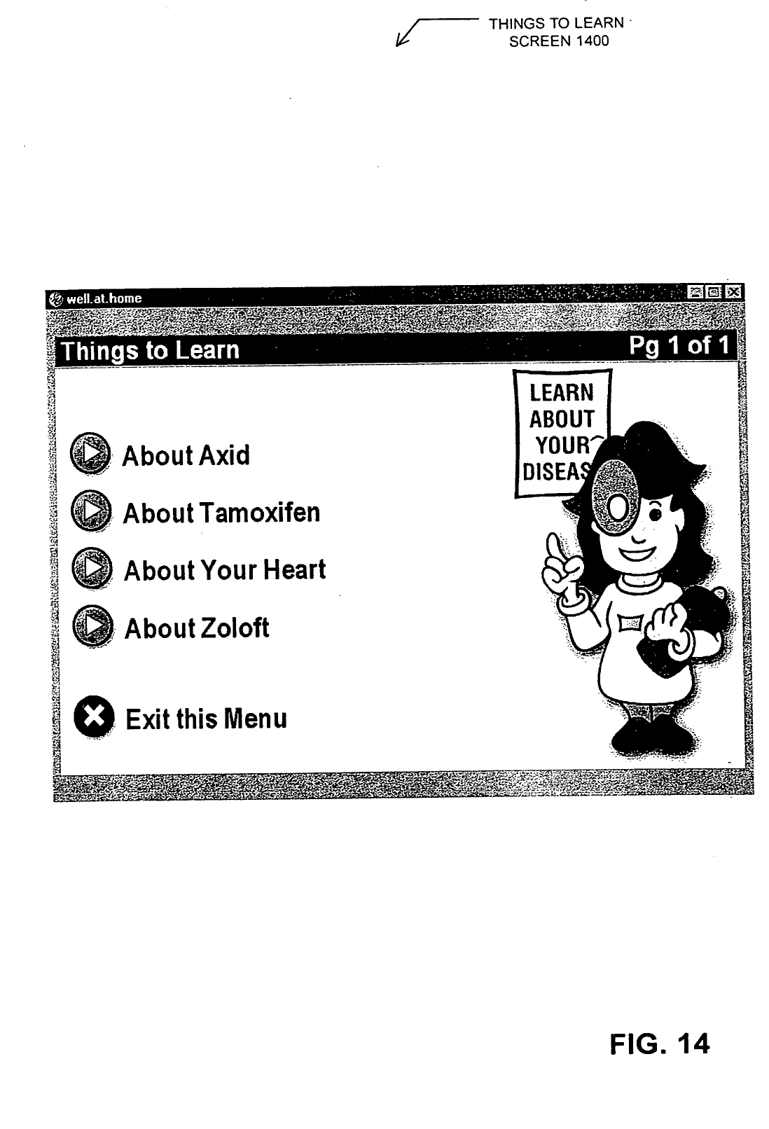

To learn more about your disease or your treatment, touch the “Things to Learn” button of the main menu screen 600 in FIG. 6. A list of topics that contain more information about your illness appears, as in the Things to Learn” screen 1400 in FIG. 14. For instance, you can learn how your illness affects our body or about the purpose and side effects of your medication.

To view more choices on the “Things to Learn” menu, touch the purple right arrow button. The purple left arrow takes you back to the previous screen.

Once you have selected an item on the “Things to Learn” menu, you can navigate through the screens by touching the yellow and green arrow buttons. Remember that a right arrow moves you forward and a left arrow moves you backward.

The buttons on the “Things to Learn” menu always remain green, allowing you to view these topics as many times as you like. To return to the main menu screen 600, touch the red “Exit this Menu” button.

### CareViews

CareViews (such as the exemplary CareViews display 500 of FIG. 5) display the data you have entered into the system for your clinician to review. The information is converted into graphs. CareViews also allow you to view your schedule, information about your treatment plan, and information about your caregivers.

To use this feature, begin at the main menu screen 600, and then touch the green arrow button next to “CareViews.” The following choices appear in a CareViews menu screen: “Schedules,” “Health Status,” “Care Plan,” and “Care Team.”

### Schedules

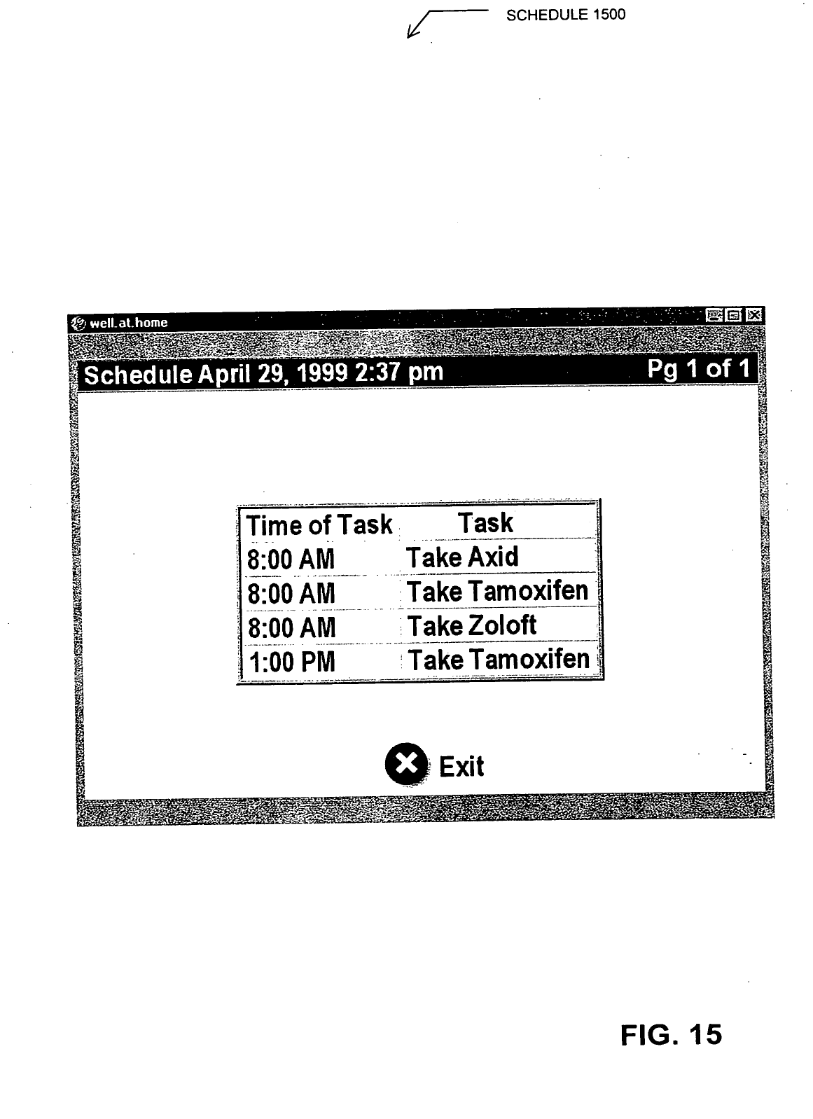

The “Schedules” feature displays your treatment schedule. On the CareViews menu, touch the button next to the “Schedules” feature. A list of dates appears. Touch the green arrow button next to the date that you want to view. This brings up a list of tasks for the date you chose, along with the time to perform each task. An example of such a task list is shown in the exemplary schedule 1500 of FIG. 15. To move forward through the schedule, touch the right purple arrow button. To move backward touch the left purple arrow button. Touch the red X button to exit the schedule and return to the list of dates.

### Health Status

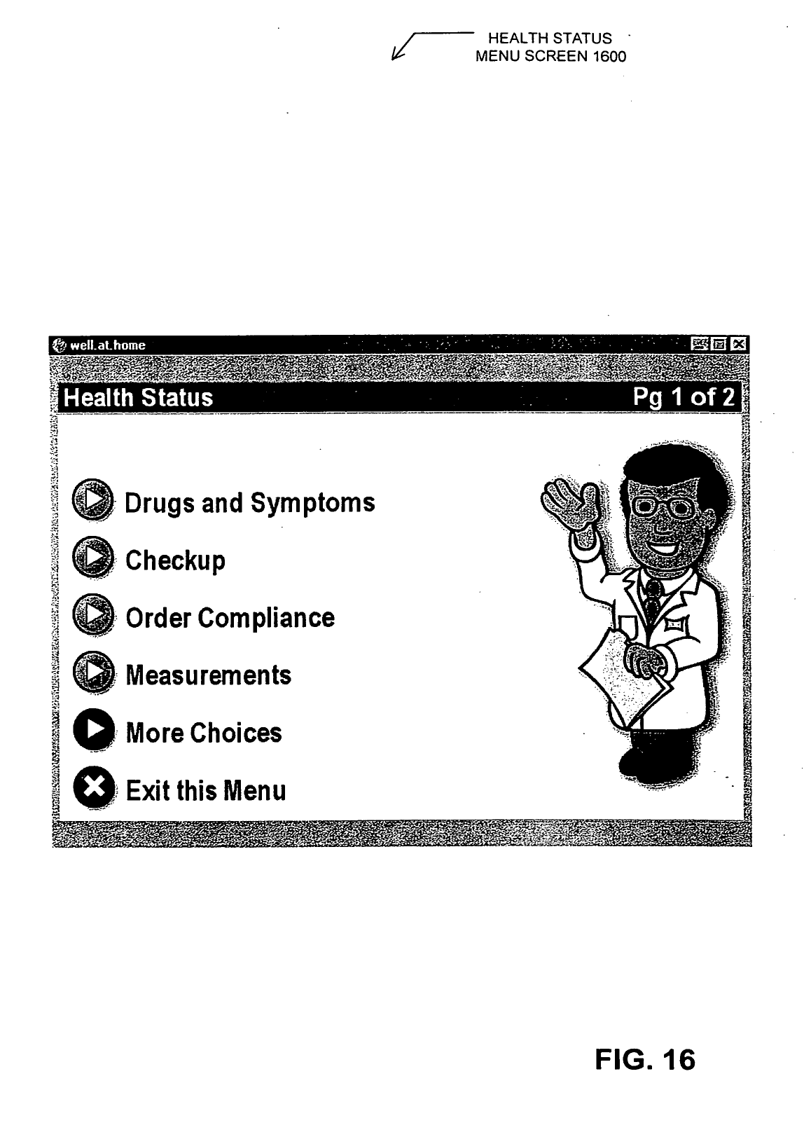

The “Health Status” feature displays a graph of your clinical information, such as CareView 500 on FIG. 5. On the CareViews menu, touch the green arrow button next to “Health Status” to see the “Health Status” menu screen 1600 of FIG. 16. The “Health Status” menu screen lists the items that you can view. After making a selection, use the purple arrow buttons to move forward to the next page of the CareView or back to the previous page. Use the yellow arrow buttons to scroll forward or backward through the dates of the CareViews. To return to the main CareViews menu screen, touch the red button marked “Done.”

### Care Plan

The “Care Plan” feature allows you to view all of the orders that have been assigned for your treatment. Select “Care Plan” from the CareViews menu screen and a list of orders appears. Choose the order you wish to view by touching the green arrow button next to it.

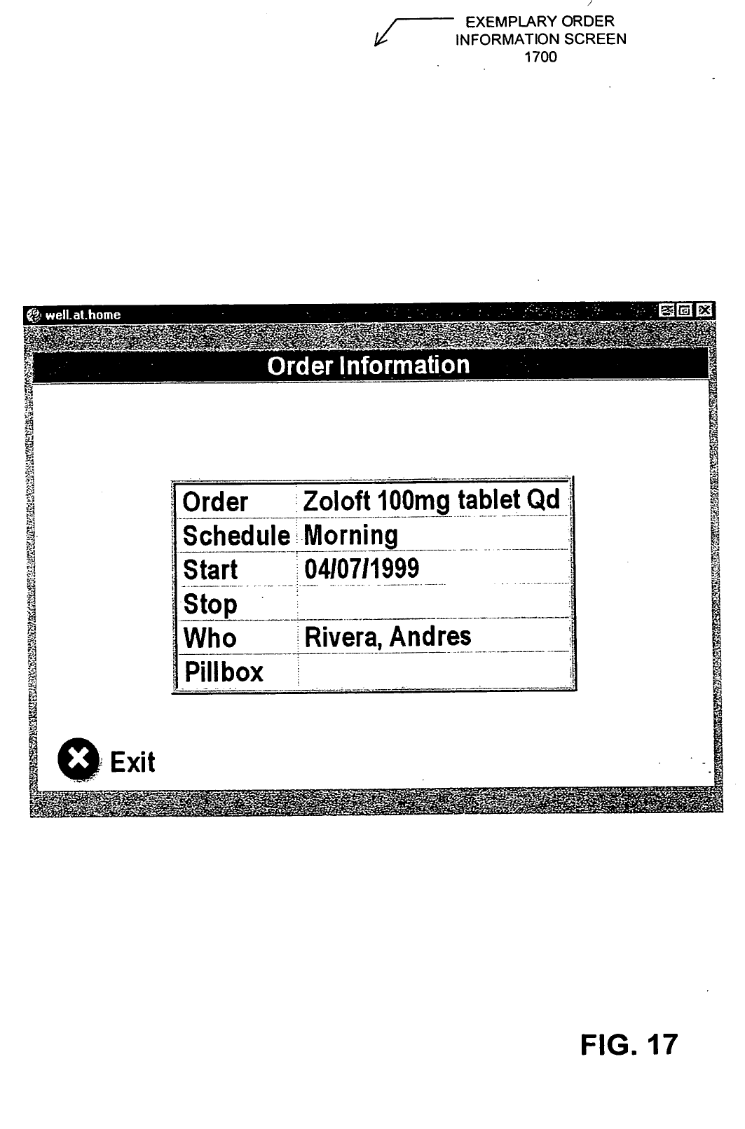

The following information about the order appears: the name of the order, the times of day for which the order is scheduled, the start date for the order, the stop date for the order (if applicable), and the clinician who placed the order. If the order is a medication, the system also lists the pillbox for the order. An exemplary order information screen 1700 is illustrated in FIG. 17. To return to the CareViews menu screen, touch the red X button.

### Care Team

The “Care Team” feature displays a list of the people who are involved with your treatment. This includes doctors, nurses, family, and friends who have access to WELL.AT.HOME and who may contribute to your chart. Touch the button next to “Care Team” in the CareViews menu screen to view the members of your care team.

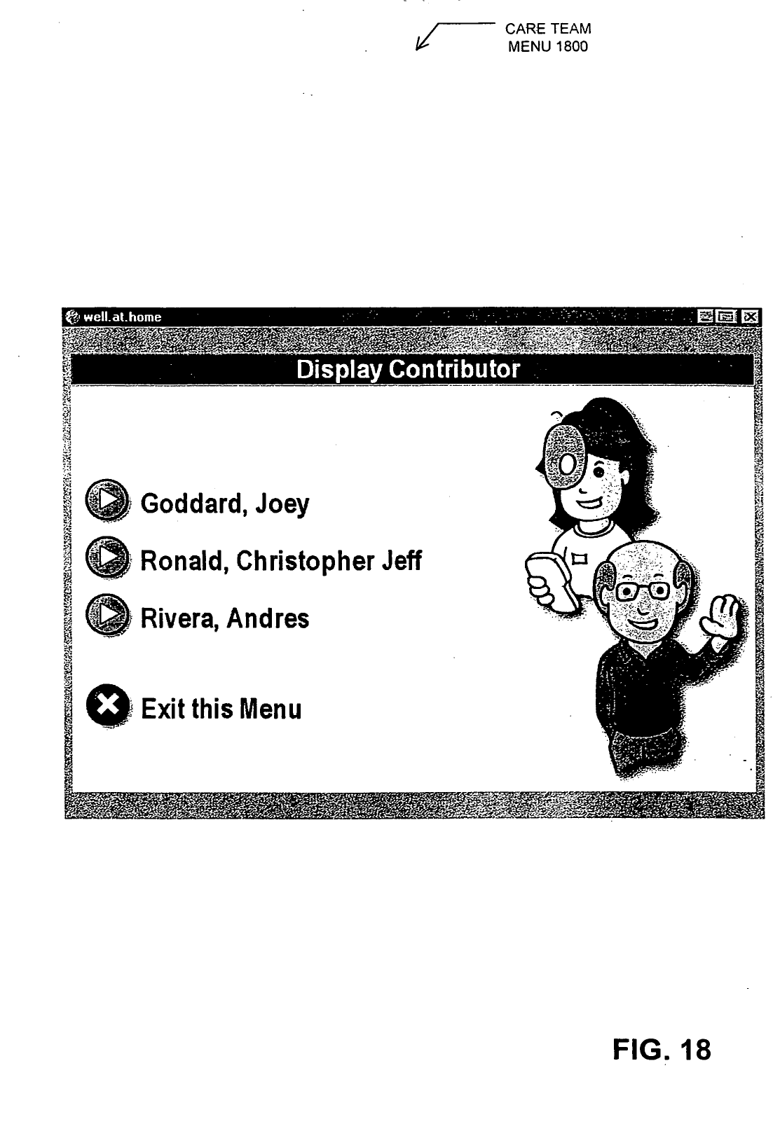

FIG. 18 illustrates an exemplary care team menu 1800 listing the members of a care team. Touching the button next to the name of any care team member displays the following information about that person: name, identification, type of clinician, phone number, institution to which the member belongs, and address. To return to the CareViews menu screen, touch the red X button.

### End of Patient Training Manual

Exemplary Clinician Training Manual

In order to provide further disclosure about the operation of the portable health assistant system 100, the detailed description now provides an exemplary training manual describing the operation of the portable health assistant system to clinicians. Again, the portable health assistant 110 is referred to as the WELL.AT.HOME device, and the portable health assistant system 100 is referred to as the WELL.AT.HOME system, or WELL.AT.HOME for short. The term “Clinician Application” refers to the functionality provided to a clinician at the server 120 through the server software or to a clinician who is remote relative to the server and is using the clinician browser 130.

### Beginning of Clinician Training Manual

### Overview of the Clinician Application

The WELL.AT.HOME Clinician Application is an integral part of the WELL.AT.HOME System. All of the information that the WELL.AT.HOME patient receives is input using the Clinician Application. Some of the many uses of the Clinician Application include creating or modifying patients' order, monitoring patients' clinical data, and creating and viewing patients' charts.

### Using the Clinician Application

The WELL.AT.HOME Clinician Application is a WINDOWS-based system. The Clinician Application screen consists of three parts: the header, the main body, and the menu area. The header is the bar at the top of the screen. The main body contains information or data entry screens. It is on the left side of the screen.

The menu area is on the right side of the screen. There are three types of menus: Tools, Options, and Index. The Tools menu is used to help navigate through the WELL.AT.HOME Clinician Application. The Tools menu choices and their functions are as follows:
“Select” Click this to choose the highlighted item from a list
“Return” Click this to go back to the previous screen or menu
“Accept” Click this to save entered information or changes and exit a screen
“Cancel” Click this to exit a screen without making changes
“Summarize” Click this to view a summary of recorded values
“Show Detail” Click this to view the possible values for an entry and to record information

The Options menu contains the Options available for performing different functions in the Clinician Application. These items vary according to what tasks need to be performed. The Options menu items and their uses are explained in more detail as you learn more about the uses of the WELL.AT.HOME Clinician Application.

The Index menu is used to help you move quickly through alphabetical multi-page lists. The Index menu shows the first item on each page. Clicking on that item will take you immediately to that page without having to scroll through numerous pages.

### Getting Started

To enter the WELL.AT.HOME clinicians' application, type your Login and Password in the sign on screen and then click “Accept” on the Tools menu.

You should now be at the Main Menu screen. The Main Menu permits you to access the features that make up the Clinician Application. The next sections describe how to access and use these features.

### Monitoring

The “Monitoring” feature is used to monitor events related to patient care. Two events are defined as default monitored events. These two events are noncompliance and non-communication. A noncompliance event occurs when a patient fails to indicate that a task derived from an order has been completed. A non-communication event occurs when the patient workstation (i.e., the portable health assistant 110) fails to communicate with the server within a specified period of time. The institution may also define other events to be monitored.

To use this feature, click on “Monitoring” from the Main Menu, then click on “Select.” Next select the date and time from which you want to monitor events. For instance, if you want to know what events have occurred since 5:00 p.m. yesterday, click on “Monitor Updates as of Date” and click on yesterday's date, then click on “Monitor Updates as of Time” and click on 5:00 p.m. Once you have selected the date and time, click “Accept” from the Tools menu. This will bring up an “Events” screen listing all events that have occurred since 5:00 p.m. yesterday.

The list will have the date on which each event occurred, the patient's name corresponding to each event, the number of events for each patient that have occurred since the date indicated, and the number of events for each patient that have had action taken. Click on the patient that you want to monitor. This will bring up a “Patient's Events” screen listing all the events that have occurred for that patient since the date indicated.

If you want to view the history of an event, click on the event and then click on “View Event” from the Options menu.

To take action, click on the event and then click on “Take Action” from the Options menu. Specify the action you will take by clicking on it. Then, click “Accept.” This will return you to the “Patient's Events” screen and a checkmark will appear next to the event that has had action taken. If you now click “Return,” you will go back to the “Events” screen, which will indicate the updated number of events for that patient for which a clinician has taken action.

### PtChart

The “PtChart” selection of the Main Menu provides you with access to a patient's clinical information. After accessing the “PtChart” selection, you can perform the following functions: creating new patient records; importing/exporting patient information; editing patient demographics; creating, modifying, and viewing patient orders; creating, modifying and viewing patient schedules; and reviewing clinical data history.

### Create New Patient Record

The “Create New Patient Record” option allows you to add a new patient to the WELL.AT.HOME system. To do so, click on “PtChart” from the Main Menu. From the “Patient Menu” screen that then appears, click on “Create New” from the Options menu. Type in the file ID of the new patient and then click on “Accept.” In the “Patient Information” screen that appears next, type in the relevant patient information. Note: you must record a value for the patient name, contributor ID, and protocol in the “Patient Information” screen. When you have completed the patient's information, click “Accept.” The new patient should now be added to the list of patients on the “Patient Menu” screen.

### View/Update Chart

To view or update the clinical information in a patient's chart, click on the patient's name in the “Patient Menu” screen that appears after choosing “PtChart” from the main menu. Then, click on “View/Update” from the Options menu. This will bring up the “Patient Overview” screen, which provides information about the patient, including name, protocol, primary doctor, and last update. From this screen you can use the Options menu to view a history of the patient's care plan or clinical data or to make changes to the patient's chart.

### CareViews

CareViews is a read only function that displays the data entered into the patient workstation in a graphical format. You can access the “CareViews” menu from the Options menu in the “Patient Overview” screen. The list of CareViews that the “CareViews” menu displays will vary depending on the patient's protocol and the patient's orders. This feature also allows you to view the patient's schedule.

Simply click on the item that you wish to view and then click “Select.” This displays a graph of the patient's clinical information. The purple buttons allow you to move forward to the next page of the CareView or back to the previous page. The yellow buttons allow you to scroll the dates forward or backward. To return to the main “CareViews” menu, click on the red button marked “Exit.” To then go back to the “Patient Overview” screen, click on “Return” in the Tools menu.

### Orders

To view or make any changes to patient orders, click on “Orders” in the “Patient Overview” screen. A list of the current orders for that patient, along with the start date for each order, will be displayed in an “Orders” screen.

### View Order

To view an order, click on the desired order in the “Orders” screen, and then click on “View Orders” from the Options Menu. This will bring up a read only screen showing that order. To return to the patient's “Orders” screen, click on “Return.”

### Add Order

To add an order, click on “Add Order” from the Options menu in the “Orders” screen. A list of protocol-specific categories of orders will be displayed. For instance, if you have selected “Type 2 Diabetes” as the protocol for your patient, “Insulin” will be one of the order categories. A few categories are common to all protocols. These are common orders, medications, activities, diet, and measurements.

Click on the category for the type of order you wish to add, then click on “Select.” This will open up a list of orders that are specific to your patient's protocol. For instance, if you assigned your patient to a diabetes protocol, the “Common Orders” category will contain orders that are widely used in the treatment of diabetes. Click on the order that you want. If this order has a desired frequency or strength (e.g., for a medication) select the desired frequency or strength by clicking on it.

The screen that follows allows you to complete the details of your order by entering the start date, stop date, and “ordered by” information. Use the “Schedule” entry to indicate the time of day that you want the patient to perform this order. (You will learn how to customize a patient's schedule in a later section.) Use the “Perform After” entry if this is an order that you want to follow a task ordered previously. Use the “How Soon After” entry to indicate how long after the previously ordered task the patient should wait before performing the order. Use the “OK To Override” entry to indicate that the patient should perform this task even if the previously ordered task is not completed.

For example, if you want your patient to take his medication 30 minutes after breakfast, make “breakfast” the value for “Perform After” and record 30 as the value for “How Soon After.” If this is the preferred method of treatment but the patient needs to take his medication regardless of whether or not he eats breakfast, choose “Yes” as the value for “OK To Override.”

### Modify Order

To modify an order, click on the desired order in the “Orders” screen and then click on “Modify Order” in the Options menu. Change values as needed, then click on “Accept” in the Tools menu to save changes and return to the patient's “Orders” screen. Click on “Cancel” to return without making changes.

### View History

To see how well a patient is complying with an order, click on the desired order in the “Orders” screen and then select “View History” from the Options menu. This option will bring up a graph that shows each day the patient was scheduled to perform the order. Each day is divided into four time periods: morning, afternoon, evening, and night (MAEN). A bar appears under the time of day that the data for that order was collected. The bar will vary in height based on the minimum and maximum values for that order. Orders that require a yes or no value will have a bar height of one if the value is yes. For a value of no, or if data was not collected, no bar will appear.

### Demographics

To edit the patient's demographics, click on “Demographics” under the Options menu in the “Patient Overview” screen. Edit the values as needed, then click on “Accept” in the Tools menu to save changes and return to the “Patient Overview” screen. Click on “Cancel” to return to the “Patient Overview” screen without making changes.

### Contributor

A contributor is anyone other than the patient who contributes data to the patient's chart. Possible contributors include doctors, nurses, social workers, family members, or friends.

To add or edit a contributor, click on “Contributors” from the “Patient Overview” screen. The “Patient Contributor Information” screen will be displayed. Click on “Add Contributor” to add a new contributor to this list. You will be shown a list of possible contributors. Click on the name of the contributor, and then click on “Add Contributor” from the Options screen. If the contributor you wish to add is not listed, click on “New Contributor” and input the contributor's information. Note: “Contributor Type” is a required field.

To edit an existing contributor's information, click on the contributor's name in the “Patient Contributor Information” screen and then on “Edit Contributor” in the Options menu. Click “Accept” to save any changes and exit.

### Patient Schedule

The “Patient Schedule” feature allows you to customize a patient's personal schedule according to his or her lifestyle. This schedule will be integrated into the WELL.AT.HOME Patient Application (i.e., the client software for the portable health assistant 110) and patient tasks will be assigned in accordance with this schedule. For example, if your patient is an early riser and normally has breakfast at 5:00 am, the WELL.AT.HOME Patient Application will alert the patient to perform breakfast-related tasks at 5:00 am rather than at 7:00 am.

To modify the patient's schedule, click on “PT's Schedule” from the “Patient Overview” screen. Click on the item you wish to change and then click “Show Detail” from the Options menu. For example, if you wish to change the time for breakfast-related tasks, select “Breakfast” and then click on “Show Detail” from the Options menu. Click on the new value (e.g., the new time for breakfast-related tasks) and then click “Accept” to save changes and exit. Click “Cancel” to exit without saving changes.

### Patient Pillbox

The “Patient Pillbox” is a tool to help patients keep track of their medications. You can customize the pillbox to match the patient's actual pillbox. WELL.AT.HOME uses this information to instruct the patient to take all the medication in the appropriate section of his or her pillbox at the appropriate time. The patient pillbox helps to alleviate confusion by giving the patient only one task to perform rather than several.

To use the pillbox, click on “PT's Pillbox” in the Options menu of the “Patient Overview” screen. Click on “Add Pillbox” in the “Pillbox” menu that appears, and then click “Select” from the Options menu. Click on “Show Detail” to add information to the new “Patient Pillbox.” Type in the name of the new pillbox and the compartment labels. Use a pillbox name that will make the pillbox easy for the patient to identify, especially if the patient has more than one pillbox. The compartment labels should be similar to the actual compartment labels on the patient's pillbox.

Under “Schedule,” enter the time of day that you want the patient to take the medication in each compartment. You should choose one of the eight segments of the day that have been customized in the patient's “Schedule.” For instance, the compartment label may be “Morning,” but the time of day that the patient needs to take the medication in that compartment may coincide with “Breakfast” on the patient's “Schedule.” At the time scheduled for “Breakfast,” WELL.AT.HOME will instruct the patient to take the pills in the pillbox compartment labeled “Morning.” All the medications scheduled for “breakfast” and assigned to that pillbox will be taken at that time.

“View Pillbox” allows you to view the “Labels” and “Schedule” for the patient's pillbox. Click on “View Pillbox” in the “Pillbox” menu, and then click “Select” from the Options menu. This will display a list of the patient's pillboxes. Click on the name of the pillbox you want to view, and then click “Select.” If you want to view the orders associated with this pillbox, click on “View Orders” from the Options menu.

### Import/Export

The WELL.AT.HOME system works by sending information between computers at your agency and computers at the patients' homes. Import/Export is used to describe the transmission of information between two computers. If a computer is receiving information it is importing it. If it is sending information it is exporting it.

As you use the WELL.AT.HOME system, it will be necessary to import and export information. Whenever you make changes to a patient's chart, you should export that information so that it will appear on the patient's workstation. To export, from the “Patient Menu” screen click on the patient's name to whom you wish to send information, and then click “Export” from the Options menu.

If you wish to gather data from the patient's workstation or copy files from another workstation at your agency, you will need to import. To import, from the “Patient Menu” screen click on the patient's name whose information you wish to receive, and then click “Import” from the Options menu.

### Delete a Patient

To delete a patient from your workstation, highlight that patient's name from the “Patient Menu” screen and then select “Delete” from the Options menu.

### Caresivers

The “Caregivers” function in the Main Menu allows you to view a list of the caregivers at your agency. Your system administrator maintains this list. To use this feature, click on “Caregivers” and then click “Select.” Click “Return” to go back to the Main Menu.

### End of Clinician Trainino Manual

Conclusion

Thus, the detailed description has described an exemplary portable health assistant system 100. Other alternative embodiments will become apparent to those skilled in the art to which an exemplary embodiment pertains without departing from its spirit and scope. Accordingly, the scope of the present invention is defined by the appended claims rather than the foregoing description.

1. A method for delivering health care through a health assistant, said method comprising:
providing a patient with the health assistant;
configuring the health assistant with a protocol comprising multimedia software content for treating a disease of the patient through the health assistant;
at a computer remote from the health assistant, receiving patient data collected by the health assistant in accordance with the protocol; and
from the remote computer, sending to the health assistant an order modifying how the protocol treats the disease.

2. The method of claim 1, wherein the remote computer is a server that the health assistant periodically accesses.

3. The method of claim 1, wherein sending the health assistant the order comprises:
sending the order from the remote computer to a server that is remotely accessible by the health assistant; and
sending the order from the server to the health assistant.

4. The method of claim 1, further comprising receiving an alert at the remote computer that the patient data merits review by a clinician.

5. The method of claim 1, wherein the patient data collected by the health assistant comprises an indicator of compliance by the patient with a treatment regimen associated with the protocol.

6. The method of claim 1, wherein the patient data collected by the health assistant comprises a symptom reported by the patient to the health assistant.

7. A computer-implementable method for providing health care under the supervision of a remote clinician, said method comprising:
providing to a patient computer, via a connection with a remote server, an order that is received from a clinician;
after the step of providing the order to the patient computer, transmitting, from the patient computer to the remote server, an indication of a symptom experienced by the patient; and
after the step of transmitting the indication of a symptom experienced by the patient, sending, from the remote server to a clinician computer, notification of the symptom so that a clinician can evaluate a need for a new order.

8. The method of claim 11, further comprising the steps of:
querying the patient to report the symptom; and
as a result of said step of querying the patient to report the symptom, receiving the indication of the symptom from the patient.

9. The method of claim 13, wherein the step of querying the patient to report the system comprises presenting multimedia information to said patient.

10. The method of claim 11, further comprising querying the patient to determine whether the patient has completed a task associated with the order.

11. The method of claim 16, further comprising notifying the remote server whether the patient has completed the task.

12. The method of claim 11, further comprising providing the patient with educational material about a disease of the patient.

13. The method of claim 13, further comprising the step of allowing a user to input the indication of a symptom experienced by the patient via a touch screen interface.

14. A computer-readable medium storing computer-executable instructions for performing the steps of:
reminding a patient to perform a task included in an order for treating the patient received from the clinician during a first connection with a remote server;
receiving from the patient an indication of a symptom experienced by the patient; and
sending notification of the symptom to the remote server during a second connection with the remote server so that the clinician can evaluate a need for a new order.

15. A computer system adapted to perform the steps of:
reminding a patient to perform a task included in an order for treating the patient received from the clinician during a first connection with a remote server;
receiving from the patient an indication of a symptom experienced by the patient; and
sending notification of the symptom to the remote server during a second connection with the remote server so that the clinician can evaluate a need for a new order.

16. A health assistant system, comprising:
a health assistant that is configured for:
periodically forming a communication connection with a remote computer server;
over the communication connection, receiving orders from a clinician for treating a patient;
instructing the patient to perform tasks included in the orders;
collecting information from the patient about symptoms experienced by the patient; and
sending the information to the computer server over the communication connection.

17. The health assistant system of claim 16, further comprising a clinician computer that is configured for:
receiving the orders from the clinician; and
sending the orders to a health assistant via the server.

18. The health assistant system of claim 16, further comprising a clinician computer that is configured for sending an alert to the clinician if the information meets predetermined criteria indicating that the clinician should be specially notified of the information.
